(19) United States
(12) Patent Application Publication
(10) Pub. No.: US 2011/0070383 A1
(43) Pub. Date: Mar. 24, 2011

(54) INKJET RECORDING MEDIUM AND METHOD OF PRODUCING SAME

(75) Inventor: Hideki Kaimoto, Kanagawa (JP)

(73) Assignee: FUJIFILM CORPORATION, Tokyo (JP)

(21) Appl. No.: 12/870,853

(22) Filed: Aug. 30, 2010

(30) Foreign Application Priority Data
Sep. 24, 2009 (JP) 2009-219481

(51) Int. Cl. B41M 5/50

(52) U.S. Cl. 428/32.34

(57) ABSTRACT

The invention provides an inkjet recording medium having at least a support and an ink-receiving layer provided on the support, the ink-receiving layer containing at least fumed silica, polyvinyl alcohol having a polymerization degree of 2400 or more, and water-soluble polyvinyl acetal, and the mass ratio of the sum of the content of the polyvinyl alcohol having a polymerization degree of 2400 or more and the content of the water-soluble polyvinyl acetal included in the ink-receiving layer to the content of all inorganic fine particles including the fumed silica in the ink-receiving layer being 50% or less.

### CROSS-REFERENCE TO RELATED APPLICATION

This application claims priority under 35 USC 119 from Japanese Patent Application No. 2009-219481 filed on Sep. 24, 2009, the disclosure of which is incorporated by reference herein.

### BACKGROUND

1. Field of the Invention

The present invention relates to an inkjet recording medium and a method of producing the inkjet recording medium.

2. Related Art

In recent years, along with rapid development in the information industry, a variety of information processing systems have been developed, and recording methods and recording devices suitable for the respective information processing systems have also been developed and put to practical use. Among these recording methods, an inkjet recording method has been widely used not only in offices but also in private homes, because the inkjet recording method has the advantages that the method allows recording on a variety of recording media, hardware (apparatus) is relatively inexpensive and compact, the method is excellent in terms of quietness, and the like.

Along with the recent trend in inkjet printers toward higher definition, various kinds of media for use in inkjet recording are being developed and, it has become possible to obtain photograph-like high-quality recorded materials. Specifically, an inkjet recording medium is generally required to have excellent image storability after recording (absence of deterioration of images such as fading or image blurring during long-term storage) as well as high ink absorption property from the viewpoint of satisfying commercial value.

### SUMMARY

Ink jet recording sheets provided with an ink-receiving layer having a 3-dimensional structure formed of inorganic pigment fine particles and water-soluble resin and has a high void volume ratio have been disclosed as recording materials having improved ink absorption property (e.g., Japanese Patent Application Laid-Open (JP-A) Nos. 10-203006, 10-217601, and 11-20306), in which these are described as providing high resolution images. Polyvinyl alcohol is referred to as a water-soluble resin used therein, and film cracking can be suppressed by using polyvinyl alcohol having a high polymerization degree. However, when a coating liquid for forming an ink-receiving layer is prepared using polyvinyl alcohol, liquid viscosity may become high and handling may become difficult, and it may be difficult to apply the coating liquid onto a support. In particular, when a fine particle dispersion is prepared and then polyvinyl alcohol is added thereto, viscosity is increased and it is very difficult to handle.

Methods in which the kind of polyvinyl alcohol is changed or two kinds of polyvinyl alcohol are used have been disclosed. Specifically, for example, a technique of using both of low polymerization-degree polyvinyl alcohol and high polymerization-degree polyvinyl alcohol together has been disclosed (e.g., JP-A No. 2000-158807).

In addition, a method including preparing a coating agent by adding a mixture liquid of polyvinyl acetal resin solution and water-soluble polyvinyl alcohol resin solution to an alumina dispersion has been disclosed (e.g., JP-A No. 2000-211246). A method including preparing a coating agent by mixing polyvinyl pyrrolidone, polyvinyl alcohol having a polymerization degree of 2000 and synthetic silica and the like has been also disclosed (e.g., Japanese Patent No. 3301681).

The use of plural kinds of polyvinyl alcohol the polymerization degrees of which are different from each other from high to low in combination may enable to expect improvements in gloss, water resistance and suppression of cracking of recording paper. However, it is difficult to improve viscosity at the time of preparing the coating liquid to be lower.

Formulation systems using an alumina dispersion liquid which has alumina as its particle component may less tend to face problems caused by increase of viscosity as compared to formulation systems using silica. The phenomenon of the increase of the liquid viscosity is easily caused by absorption of polyvinyl alcohol to a pigment which may occur when the polyvinyl alcohol has a high polymerization degree and is mixed with the pigment. This phenomenon may be remarkable when the polyvinyl alcohol has a low saponification degree (i.e., hydrophobic). This phenomenon may be further remarkable when the formulation uses fumed silica as the pigment.

The phenomenon of the increase of viscosity of the coating liquid may cause a decrease of handling property and coating property, and may bring about tendencies to decrease image density and a degree of bleeding resistance (blurring resistance, humidity resistance) when the image is recorded.

The present invention was made in consideration of the above circumstances.

One exemplary embodiment of a first aspect of the present invention is <1> an inkjet recording medium comprising a support and an ink-receiving layer provided on the support, the ink-receiving layer comprising fumed silica, polyvinyl alcohol having a polymerization degree of 2400 or more, and water-soluble polyvinyl acetal, and the mass ratio of the sum of the content of the polyvinyl alcohol having a polymerization degree of 2400 or more and the content of the water-soluble polyvinyl acetal included in the ink-receiving layer to the content of all inorganic fine particles including the fumed silica in the ink-receiving layer being 50% or less.

Another exemplary embodiment of the first aspect of the present invention is <2> the inkjet recording medium of <1>, wherein in ink-receiving layer, the content of the polyvinyl alcohol having a polymerization degree of 2400 or more is from 12% by mass to 35% by mass with respect to the content of all inorganic fine particles, and the content of the water-soluble polyvinyl acetal is from 1% by mass to 7% by mass with respect to the content of the fumed silica.

Another exemplary embodiment of the first aspect of the present invention is <3> the inkjet recording medium of <1> or <2>, wherein the saponification degree of the polyvinyl alcohol having a polymerization degree of 2400 or more is from 78 mol % to 96 mol %.

One exemplary embodiment of a second aspect of the present invention is <4> a method of producing an inkjet recording medium, the method comprising: preparing a coating liquid by adding polyvinyl alcohol having a polymerization degree of 2400 or more and water-soluble polyvinyl acetal to a silica dispersion comprising fumed silica so that the mass ratio of the sum of the content of the polyvinyl alcohol having a polymerization degree of 2400 or more and the content of the water-soluble polyvinyl acetal to the content of all inorganic fine particles in the coating liquid becomes 50% or less; and forming an ink-receiving layer by applying the coating liquid onto a support.

Another exemplary embodiment of the second aspect of the present invention is <5> the method of producing the inkjet recording medium of <4>, wherein the preparing of the coating liquid comprises preparing the coating liquid so that the mass ratio of the content of the polyvinyl alcohol having a polymerization degree of 2400 or more to the content of all inorganic fine particles in the coating liquid is from 12% by mass to 35% by mass and the mass ratio of the content of the water-soluble polyvinyl acetal to the content of the fumed silica in the coating liquid is from 1% by mass to 7% by mass.

### DETAILED DESCRIPTION

### Inkjet Recording Medium

The inkjet recording medium of one exemplary embodiment of one aspect of the invention has at least a support and an ink-receiving layer provided on the support. The ink-receiving layer contains at least fumed silica, polyvinyl alcohol having a polymerization degree of 2400 or more, and water-soluble polyvinyl acetal. The mass ratio of the sum of the content of the polyvinyl alcohol and the content of the water-soluble polyvinyl acetal included in the ink-receiving layer to the content of all inorganic fine particles including the fumed silica in the ink-receiving layer is 50% or less. In embodiments, the ink-receiving layer may further contain other components such as a crosslinking agent.

Herein, the high-polymerization-degree polyvinyl alcohol having the polymerization degree of 2400 or more is mixed with the dispersion liquid containing the fumed silica together with the water-soluble polyvinyl acetal, which may be contained in a small amount. Since the water-soluble polyvinyl acetal is compatible with the polyvinyl alcohol, hydrophobic property of the polyvinyl alcohol may be promoted and the absorption of the polyvinyl alcohol to the fumed silica may be suppressed. For this reason, when a coating liquid for the ink-receiving layer is prepared by mixing the fumed silica with the high polymerization-degree polyvinyl alcohol, the liquid viscosity may be made to be low. In addition, the humidity resistance of an image recorded on the inkjet recording medium may increase, and occurrence of bleeding of the image may be suppressed. Accordingly, application of the coating liquid for the ink-receiving layer may become easy, and the ink-receiving layer may provide high image density, excellent humidity resistance and excellent water resistance.

Fumed Silica

The ink-receiving layer (or a coating liquid for forming the ink-receiving layer) contains fumed silica. In general, silica fine particles are classified roughly into wet-method particles and dry-method (vapor-phase-method) particles depending on the production method therefor. The vapor-phase-methods are classified roughly into the flame hydrolysis process and the arc method. In the flame hydrolysis process, generally, a silicon halide is hydrolyzed in a vapor phase at high temperature to form anhydrous silica fine particles; and in the arc method, generally, quartz and coke are reduced and vaporized in an electric furnace by applying arc discharge, followed by air oxidation, to thereby form anhydrous silica fine particles. The “fumed silica” herein refers to anhydrous silica fine particles produced by the vapor-phase-method, and is different from hydrous silica obtained by the wet method, in which a silicate salt is generally decomposed with an acid to produce an active silica, and the active silica is polymerized to a suitable extent to cause aggregation-precipitation.

The fumed silica have different properties from the hydrous silica. For example, the f fumed silica contains voids unlike the hydrous silica, and they are also different in the density of silanol groups present on the surface. The fumed silica is suitable for forming a three-dimensional structure with high void volume ratio. The reason for this is supposed as follows: hydrous silica fine particles have a higher density of silanol groups present on their surfaces (about 5 groups to 8 groups/nm2), leading to dense gathering (aggregation); in contrast, fumed silica fine particles have a lower density of silanol groups present on their surfaces (about 2 groups to 3 groups/nm2), leading to loose gathering (flocculation) and thus forming a three-dimensional structure with high void volume ratio.

The fumed silica (anhydrous silica) is preferably fumed silica particles having the density of silanol groups present on their surfaces of from 2 groups/nm² to 3 groups/nm². The specific surface area of the fumed silica fine particles, measured by a BET method, may be preferably 200 m²/g or more, more preferably 250 m²/g or more, particularly preferably 380 m²/g or more. When the specific surface area is 200 m²/g or more, the ink-receiving layer may have high transparency and printing density.

The BET method is described in item 2.2 the technical information No. 10 available from Japan Aerosil Co., Ltd., the disclosure of which is herein incorporated in its entirety by reference, and the like as a method for measuring an average particle diameter of primary particles. The BET method is one of methods for measuring a surface area of a powder by a vapor-phase adsorption method. This method finds a total surface area of 1 g of a sample, that is, a specific surface area from an adsorption isotherm. Nitrogen gas is most often used as the adsorption gas, and the adsorbed amount of gas is most often measured from the pressure or volume variations of the adsorption gas. An equation suggested by Brunauer, Emmett, and Teller, which is called a BET equation, is the most famous equation representing an isotherm of multimolecular adsorption and it is widely used for determining the surface area. A surface area can be found by finding the adsorption amount based on the BET equation and multiplying by the area taken by one adsorbed molecule on the surface.

An average primary particle diameter of the inorganic fine particles may be preferably 20 nm or less, more preferably 15 nm or less, and further preferably 10 nm or less. When the average primary particle diameter is 20 nm or less, high ink-absorbing speed of the ink-receiving layer may be effectively improved, and glossiness of a surface of the ink-receiving layer may be also improved.

Specifically, silica fine particles are easier to stick to one another due to hydrogen bonds formed by silanol groups on the surfaces thereof and the adhering effect via the silanol groups and the water-soluble resin (such as polyvinyl alcohols). Therefore, the ink-receiving layer may have a structure having a high void volume ratio and high transparency when the average primary particle diameter of the inorganic fine particles may be preferably 20 nm or less m thereby effectively improving ink-absorbability.

The content of the fumed silica may be preferably from 50% by mass, and more preferably from 60% by mass, with respect to the total solid content of the ink-receiving layer (or the total solid content of a coating liquid for forming the ink-receiving layer). When the content of the fumed silica satisfies such range, the porous structure of the ink-receiving layer may be improved, which may lead to excellent ink absorption property.

The “total solid content of the ink-receiving layer” herein means a content calculated based on components which form the ink-receiving layer except for water.

Polyvinyl Alcohol

The ink-receiving layer (and a coating liquid for forming the ink-receiving layer of in embodiments) contains at least one kind of polyvinyl alcohol (hereinafter, referred to as “PVA”) having a polymerization degree of 2400 or more. Uses of high polymerization-degree PVA with the polymerization degree of 2400 or more tend to cause remarkable increase of viscosity due to absorption of the PVA to the fumed silica. The addition of water-soluble polyvinyl acetal as a binder component to the high polymerization-degree PVA may be highly effective for resolving the increase of viscosity.

The polymerization degree of the PVA, which herein refers to an average polymerization degree of the PVA, is 2400 or more, and may be preferably from 2400 to 5000, and more preferably from 3000 to 5000. When the average polymerization degree of the PVA is smaller than 2400, the ink-receiving layer may tend to cause cracking, and density image formed on the ink-receiving layer may be inferior. According to exemplary embodiments, the viscosity of the coating liquid for forming the ink-receiving layer may be kept low although the average polymerization degree of the PVA is 2400 or more. The “polymerization degree” of the PVA herein refers to values provided by manufacturers of the PVA or values obtained by generally-known measuring method such as that described in “Journal of Applied Polymer Science” Vol. 102 (5), pp. 4831, the disclosure of which is herein incorporated in its entirety by reference.

The polyvinyl alcohol may be a modified polyvinyl alcohol, and examples thereof include acetoacetyl-modified polyvinyl alcohols, cationic modified polyvinyl alcohols, anionic modified polyvinyl alcohols, and silanol-modified polyvinyl alcohols.

Examples of the polyvinyl alcohol further include those described in JP-A Nos. 4-52786, 5-6743, 7-29479, 7-57553, 63-176173, 7-276787, 9-207425, 11-58941, 2000-135858, 2001-205924, 2001-287444, 62-278080, 9-39373, 2000-158801, 2001-213045, 2001-328345, 8-324105, and 11-348417, and Japanese Patent Nos. 2537827, 2502998, 3053231, and 2604367.

The saponification degree of the polyvinyl alcohol may be preferably from 70 mol % to 99 mol %, and more preferably from 78 mol % to 96 mol %, in view of decreasing viscosity of the coating liquid for forming the ink-receiving layer. The saponification degree of 99 mol % or less may facilitate to suppress curling of the recording medium, and the saponification degree of 70 mol % or more may facilitate to decrease viscosity of the coating liquid for forming the ink-receiving layer.

In embodiments, a polyvinyl alcohol which has a polymerization degree which is lower than that of the polyvinyl alcohol having the polymerization degree of 2400 or more may be further contained in the ink-receiving layer. The polymerization degree of the polyvinyl alcohol having the lower polymerization degree may be preferably from 200 to 900, and more preferably from 300 to 600. The polymerization degree of 200 or more may facilitate to suppress cracking of the ink-receiving layer, and the polymerization degree of 900 or less may facilitate to decrease viscosity of the coating liquid for forming the ink-receiving layer.

In the case in which polyvinyl alcohol which has a polymerization degree which is lower than that of the polyvinyl alcohol having the polymerization degree of 2400 is used, the ratio of the content of the polyvinyl alcohol having the lower polymerization degree to that of the polymerization degree of 2400 or more (lower polymerization degree-PVA: PVA having the polymerization degree of 2400 or more) may be preferably from 1:1 to 1:5, and more preferably from 1:2 to 1:4.

The content of the polyvinyl alcohol having the polymerization degree of 2400 or more may be preferably from 5% by mass to 30% by mass, and more preferably from 10% by mass to 20% by mass, with respect to the total solid content of the ink-receiving layer (or the total solid content of the coating liquid for forming the ink-receiving layer).

The content of the polyvinyl alcohol having the polymerization degree of 2400 or more may be preferably from 12% by mass to 35% by mass with respect to the content of all inorganic fine particles contained in the ink-receiving layer (with respect to the sum of content(s) of all inorganic fine particles contained in the coating liquid for forming the ink-receiving layer). This content of 12% by mass may facilitate to suppress cracking of the ink-receiving layer, and this content of 35% by mass or less may facilitate to provide high image density. In embodiments, this content may be more preferably from 17% by mass to 23% by mass.

Water-Soluble Polyvinyl Acetal

The ink-receiving layer (the coating liquid for forming the ink-receiving layer) contains at least one kind of water-soluble polyvinyl acetal (hereinafter, also referred to as “PVAc”). Herein, “water solubility” means a property that an amount of dissolved PVAc is 1 g or more when the PVAc is added in 100 ml of water at 20° C.

The polyvinyl acetal may be a polymer obtained by acetalizing polyvinyl alcohol by reacting aldehyde therewith, and may be a polymer obtained by using, as a starting material, a compound in which some or all of a molecule of polyvinyl alcohol is esterified (such as vinyl acetate), and performing saponification and acetalization together. Any known method such as a dissolution method, a precipitation method, or a homogeneous system method may be employed as the acetalization method.

The polyvinyl alcohol used as the material of the polyvinyl acetal is not particularly limited. Generally, the polymerization degree of the polyvinyl alcohol may be from 300 to 4500, and may be preferably from 500 to 4500. The higher the polymerization degree of polyvinyl acetal is, the better the water resistance of the ink-receiving layer may become. The saponification degree of the polyvinyl alcohol component is also not particularly limited. Generally, the saponification degree may be from 80.0 mol % to 99.5 mol %. As long as the saponification degree is within the range of keeping water solubility, the smaller the saponification degree is, the better the humidity resistance may become.

Examples of the aldehyde used as the raw material of the polyvinyl acetal include: aliphatic aldehydes such as formaldehyde, acetaldehyde, butylaldehyde, hexylaldehyde, octylaldehyde, and decyaldehyde; benzaldehyde; alkyl-substituted benzaldehydes such as 2-methylbenzaldehyde, 3-methylbenzaldehyde, and 4-methylbenzaldehyde; halogen-substituted benzaldehyde such as chlorobenzaldehyde; aromatic aldehydes such as phenylacetaldehyde, β-phenylpropionaldehyde, and phenyl-substituted alkylaldehyde; and aromatic aldehydes having a substituent group such as a hydroxyl group, an alkoxyl group, an amino group, or a cyano group in its aromatic ring. In embodiments, the aldehydes may be those having a condensed aromatic ring, examples thereof including naphtoaldehydes and anthraaldehydes.

In embodiments, among these, aliphatic aldehydes having an alkyl part having 2 to 6 carbon atoms may be preferable, and butylaldehyde, acetaldehyde, and hexylaldehyde may be particularly preferable from the viewpoint of obtaining resin having sufficient water solubility, excellent water resistance and excellent transparency.

Generally, an acetalization degree of the olyvinyl acetal may be preferably from 2 mol % to 40 mol %, more preferably from 3 mol % to 35 mol %, and still more preferably from 15 mol % to 35 mol %. The acetalization degree of 2 mol % or more and within a range of not too low may facilitate to maintain excellent humidity resistance, and the acetalization degree of 40 mol % or less and is within a range of not too high may facilitate to maintain excellent water solubility.

Examples of the water-soluble polyvinyl acetal include commercially available S-LEC (trade name, manufactured by Sekisui Chemical Co., Ltd.).

The content of the water-soluble polyvinyl acetal may be preferably from 0.3% by mass to 12% by mass ration with respect to the sum of contents of all the inorganic fine particles included in the ink-receiving layer or the coating liquid for forming the ink-receiving layer. When the content of the water-soluble PVAc is equal to or more than 0.3% by mass, the increase of the liquid viscosity may be suppressed and the humidity resistance and water resistance may be improved. When the content of the water-soluble PVAc is equal to or less than 12% by mass, there may be an advantage in suppressing cracking of the ink-receiving layer.

The content of the water-soluble polyvinyl acetal may be preferably from 1% by mass to 7% by mass with respect to the content of the fumed silica. When the ratio of the content of the water-soluble PVAc to the content of the fumed silica is equal to or more than 1% by mass, the increase of the liquid viscosity may be suppressed and the humidity resistance and water resistance may be improved. When the content is equal to or less than 7% by mass, there may be advantages in suppression of cracking of the ink-receiving layer and color density of images formed on the ink-receiving layer.

In embodiments, the ratio of the sum of the content of the polyvinyl alcohol of the polymerization degree of 2400 and the content of the water-soluble polyvinyl acetal to the content of all inorganic fine particles (including the fumed silica) in the ink-receiving layer (namely, [(total content of PVA)+(total content of PVAc)]/(sum of contents of all inorganic fine particles)) may be 50% by mass or less, and more preferably 30% by mass or less. The lower limit of the ratio may be preferably 12% by mass. When the ratio is more than 50% by mass, the increase of the liquid viscosity at the time of preparing the coating liquid for forming the ink-receiving layer may become large, images recorded on the formed ink-receiving layer may hardly to obtain high image density, and the humidity resistance and water resistance of the ink-receiving layer may be inferior.

Herein, the “sum of contents of all inorganic fine particles” means the total mass of inorganic fine particles including the fumed silica.

In embodiments, the ink-receiving layer of the ink jet recording medium or the coating liquid thereof may preferably includes polyvinyl alcohol having an average polymerization degree of from 3000 to 4000 and water-soluble polyvinyl acetal, in which the ratio of the sum of the content of the polyvinyl alcohol and the content of the water-soluble polyvinyl acetal to the content of the fumed silica (namely, [(total content of PVA)+(total content of PVAc)]/(content of fumed silica)) is from 15 to 30% by mass.

The ink-receiving layer or the coating liquid for forming the ink-receiving layer may further contain inorganic fine particles other than the fumed silica particles, one or more water-soluble resin(s) other than the PVA, and/or the like as long as the effects obtained by the inkjet recording medium is not affected thereby.

Examples of the inorganic fine particles other than the fumed silica include pigments such as colloidal silica, titanium dioxide, barium sulfate, calcium silicate, zeolite, kaolinite, halloysite, mica, talc, calcium carbonate, magnesium carbonate, calcium sulfate, alumina fine particles, boehmite, pseudo-boehmite, kaolin, clay, sintered clay, zinc oxide, aluminum oxide, aluminum hydroxide, satin white, aluminium silicate, synthetic zeolite, sepiolite, smectite, synthetic smectite, magnesium silicate, magnesium oxide, diatomaceous earth, and hydrotalcite.

Examples of the water soluble resin other than PVA include cellulose resins (for example, methyl cellulose (MC), ethyl cellulose (EC), hydroxyethyl cellulose (HEC), carboxymethyl cellulose (CMC), hydroxypropyl cellulose (HPC), hydroxyethyl methyl cellulose and hydroxypropyl methyl cellulose), chitins, chitosans, starch, resins having ether bonds (for example, polypropylene oxide (PPO), polyethylene glycol (PEG), and polyvinyl ether (PVE)), resins having carbamoyl groups (for example, polyacrylamide (PAAM), polyvinyl pyrrolidone (PVP) and polyacrylic acid hydrazide). Examples of the water soluble resin other than PVA further include those having carboxy groups as dissociation groups, such as polyacrylic acid, maleic acid resins, alginic acid, and gelatin.

Examples of the water soluble resin other than PVA further include compounds described in paragraphs [0011] to [0014] in JP-A No. 11-165461.

These water soluble resins may be used alone, or in a combination of two or more of them.

Other Components

In embodiments, the ink-receiving layer and the coating liquid for forming the ink-receiving layer may further contain, in addition to the components described above, other component(s) described below.

Crosslinking Agent

In embodiments, the ink-receiving layer and the coating liquid for forming the ink-receiving layer may contain a crosslinking agent which crosslinks components of the ink-receiving layer, the main component of which being the PVA. In embodiments, the ink-receiving layer may have a porous structure formed by curing via crosslinking reaction between the crosslinking agent and the PVA.

Preferable examples of the crosslinking agent include a boron compound. Examples of the borate compound include borax, boric acid, borate salts [e.g., orthoborate salts, InBO₃, ScBO₃, YBO₃, LaBO₃, Mg₃(BO₃)₂, and CO₃(BO₃)₂], diborate salts [e.g., Mg₂B₂O₅, and CO₂B₂O₅], metaborate salts [e.g., LiBO₂, Ca(BO₂)₂, NaBO₂, and KBO₂], tetraborate salts [e.g., Na₂B₄O₇·10H₂O], and pentaborate salts [e.g., KB₅O₈·4H₂O, Ca₂B₆O₁₁·7H₂O, and CsB₅O₅]. Among them, borax, boric acid and borates may be preferable, and boric acid may be more preferable for further progressing rapid crosslinking reaction.

Examples of the crosslinking agent further include aldehyde compounds such as formaldehyde, glyoxal, and glutaraldehyde; ketone compounds such as diacetyl and cyclopentanedione; active halide compounds such as bis(2-chloroethylurea)-2-hydroxy-4,6-dichloro-1,3,5-triazine and sodium salts of 2,4-dichloro-6-S-triazine; active vinyl compounds such as divinylsulfonic acid, 1,3-vinylsulfonyl-2-propanol, N,N′-ethylene bis(vinylsulfonylacetamide), and 1,3,5-triacryloyl-hexahydro-5-triazine; N-methylol compounds such as dimethylolurea and methyloldimethylhydantoin; melamine resins such as methylolmelamine and alkylated methylolmelamines; epoxy resins;

isocyanate compounds such as 1,6-hexamethylene diisocyanate; aziridine compounds described in U.S. Pat. No. 3,017,280 and U.S. Pat. No. 2,983,611; carboxyamide compounds described in U.S. Pat. No. 3,100,704; epoxy compounds such as glycerol triglycidyl ether; ethyleneimino compounds such as 1,6-hexamethylene-N,N′-bisethyleneurea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potash alum, zirconyl acetate, and chromium acetate; polyamine compounds such as tetraethylenepentamine; hydrazide compounds such as adipic acid dihydrazide; and low-molecular compounds and polymers having 2 or more oxazoline groups. The crosslinking agents may be used singly or in combination of two or more.

In embodiments, the crosslinking and curing may be preferably carried out by: adding a crosslinking agent to a basic liquid having a pH of 8 or more and/or a coating liquid that contains the fumed silica, the polyvinyl alcohol having the polymerization degree of 2400 or more, and the water-soluble polyvinyl acetal; and applying, either (1) at the same time when the coating liquid is applied to form a coating layer or (2) during the course of drying the coating layer formed by applying the coating liquid and before the coating liquid (coating layer) exhibits decreasing rate of drying, the basic liquid to the coating layer.

In embodiments, in the case in which the ink-receiving layer is a layer formed by crosslinking and curing a coating layer formed by applying a coating liquid that contains the fumed silica, the polyvinyl alcohol having the polymerization degree of 2400 or more, and the water-soluble polyvinyl acetal, the application of the crosslinking such as a boron compound may be preferably carried out by, for example, applying, either (1) at the same time when the coating liquid is applied to form a coating layer or (2) during the course of drying the coating layer formed by applying the coating liquid and before the coating liquid (coating layer) exhibits decreasing rate of drying, a basic liquid having a pH of 8 or more to the coating layer. In such a case, the boron compound used as the crosslinking may be incorporated in at least one of the coating liquid or the basic liquid, and may be incorporated in both of the coating liquid and the basic liquid.

The amount of the crosslinking agent to be used is preferably 1 mass % to 50 mass %, and more preferably 5 mass % to 40 mass % based on the content of the water-soluble resin.

Mordant

In embodiments, the ink-receiving layer may further contain a mordant. The use of the mordant may enhance the water resistance of a formed image and a resistance to bleeding over time.

Examples of the mordant include an organic mordant such as cationic polymers (cationic mordants) and an inorganic mordant. When the mordant is present in the ink-receiving layer, the mordant may interact with a liquid ink containing an anionic dye as a colorant to stabilize the colorant, whereby the water resistance and the bleeding over time can be further improved. The organic mordant and the inorganic mordant may be respectively used either singly or in combination of two or more. In embodiments, both of the organic mordant and the inorganic mordant may be used in combination.

Examples of the cationic mordant include polymer mordants having, as a cationic functional group, a primary- to tertiary-amino group or a quaternary ammonium salt group. In embodiments, a cationic non-polymer mordant may also be used.

Examples of the polymer mordant include a homopolymer of a mordant monomer (namely, a monomer having a primary- to tertiary-amino group or its salt or a monomer having a quaternary ammonium salt group) or a copolymer or condensed polymer of the mordant monomer and other monomers (hereinafter referred to as “non-mordant monomer”). These polymer mordants may be used in any form of a water-soluble polymer or water-soluble latex particles. Specific examples of the mordant monomer and the non-mordant monomer to form the polymer mordant include monomers shown in paragraphs to [0051] of JP-A No. 2005-81645.

Specific examples of the mordant further include monomers shown in paragraphs [0052] to [0053] of JP-A No. 2005-81645.

In embodiments, polyallylamine and a derivative thereof may be preferable as the polymer mordant. In embodiments, polyallylamine having a volume-average molecular weight of 100,000 or less and a derivative thereof may be further preferable in view of suppressing bleeding over time. Various known allylamine polymers and derivatives thereof may be used as the polyallylamine or its derivatives. Examples of the derivatives include salts of polyallylamine and acids (the acids are, for example, inorganic acids such as hydrochloric acid, sulfuric acid, phosphoric acid and nitric acid, and organic acids such as methanesulfonic acid, toluenesulfonic acid, acetic acid, propionic acid, cinnamic acid and (meth)acrylic acid) or combinations of these salts and those which are salts of only a part of polyallylamine and acids, modified compounds obtained by a high-molecular reaction of polyallylamine and copolymers of polyallylamine and other copolymerizable monomers (specific examples of the other monomers include (meth)acrylates, styrenes, (meth)acrylamides, acrylonitrile and vinyl esters). Specific examples of the polyallylamine and derivatives thereof include those described in paragraph [0056] of JP-A No. 2005-81645.

Examples of the inorganic mordant include polyvalent water-soluble metal salts and hydrophobic metal salt compounds, and polyvalent water-soluble metal salts may be preferable. Specific examples of the inorganic mordant include salts or complexes of metals selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth. Specific examples thereof further include a compound shown in paragraph 0058 of JP-A No. 2005-81645. In embodiments, aluminum-containing compounds, titanium-containing compounds, zirconium-containing compounds and compounds (salts or complexes) of metals of the IIIB group in the periodic chart may be preferable.

The amount of the mordant to be added in the ink-receiving layer and the coating liquid for forming the ink-receiving layer may be preferably 0.01 g/m² to 5 g/m², and may be more preferably 0.1 g/m² to 3 g/m².

Other Components

The ink-receiving layer or the coating liquid for forming the ink-receiving layer may further contain, besides the essential components thereof, various known additives such as an ultraviolet ray absorber, an antioxidant, a fluorescent a whitening agent, a monomer, a polymerization initiator, a polymerization suppressor, a bleeding preventing agent, an antiseptic, a viscosity stabilizer, an antifoaming agent, a surfactant, an antistatic agent, a matt agent, a curling preventing agent, a water preventing agent, or a high-boiling temperature organic solvent according to the need. In embodiments, surfaces of the inorganic fine particles may be treated with a silane coupling agent in view of improving dispersibility of the inorganic fine particles.

Details of these additives are described in paragraphs [0061] to [0067] and [0069] to [0076] of JP-A No. 2005-81645.

Such other components may be used either singly or in combination of two or more. These other components may be added, to the coating liquid for forming the ink-receiving layer, in the form of water-soluble state, polymer dispersion, emulsion, or oil droplets. In embodiments, these other components may be contained a microcapsule to be added to the coating liquid. The content of these other components in the ink-receiving layer may be preferably 0.01 g/m² to 10 g/m².

Method of Producing Inkjet Recording Medium

The inkjet recording medium may be produced by any method as long as it enables forming the ink-receiving layer containing at least fumed silica, polyvinyl alcohol having a polymerization degree of 2400 or more, and water-soluble polyvinyl acetal, in which the mass ratio of the sum of the content of the polyvinyl alcohol and the content of the water-soluble polyvinyl acetal included in the ink-receiving layer to the content of all inorganic fine particles in the ink-receiving layer is 50% or less. In embodiments, the inkjet recording medium may be produced by applying, onto a support, a coating liquid containing at least fumed silica, polyvinyl alcohol having a polymerization degree of 2400 or more, and water-soluble polyvinyl acetal, and drying the coating liquid applied on the support.

The ink-receiving layer forming liquid may be prepared by, for example, dispersing fumed silica fine particles and a dispersant by subjecting these to counter collision by using an ultrasonic disperser or a high-pressure disperser, or having passing these through an orifice so as to prepare a dispersion liquid of the fumed silica fine particles; and adding the PVA having the polymerization degree of 2400 or more and the water-soluble polyvinyl acetal to the dispersion liquid. Pre-mixing of the fumed silica fine particles and the PVA having the polymerization degree of 2400 or more and the water-soluble polyvinyl acetal may be performed by usual screw stirring, turbine stirring, homomixer stirring or the like. Examples of the high-pressure disperser include a commercially-available apparatus which is generally called as a high-pressure homogenizer. Typical examples of the high-pressure homogenizer include NANOMIZER (trade name, manufactured by Nanomizer), MICROFLUIDIZER (trade name, manufactured by Microfluidix), and ALTIMIZER (trade name, manufactured by Sugino Machine Incorporated). The “orifice” refers to a member having a mechanism in which a thin plate (orifice plate) having a minute hole (the shape thereof may be a circle or the like) is disposed in a straight pipe to rapidly reduce the sectional area of the flow path in the straight pipe.

In embodiments, the inkjet recording medium may be produced by a method including at least: preparing a coating liquid by adding polyvinyl alcohol having the polymerization degree of 2400 or more and water-soluble polyvinyl acetal to a silica dispersion containing at least fumed silica so that the mass ratio of the sum of the content of the polyvinyl alcohol and the content of the water-soluble polyvinyl acetal to the content of all inorganic fine particles in the coating liquid becomes 50% or less; and forming the ink-receiving layer by applying the coating liquid onto a support.

Preparation of Coating Liquid

The process of preparing the coating liquid (coating liquid for forming the ink-receiving layer) includes providing a silica dispersion in which the fumed silica is dispersed in advance and adding, to the silica dispersion, the PVA having the polymerization degree of 2400 or more and the water-soluble polyvinyl acetal so that the mass ratio of the sum of the content of the polyvinyl alcohol and the content of the water-soluble polyvinyl acetal included in the ink-receiving layer to the content of all inorganic fine particles in the ink-receiving layer is 50% or less. Details of the fumed silica, the PVA having the polymerization degree of 2400 or more and the water-soluble polyvinyl acetal are described above.

The coating liquid for forming the ink-receiving layer can be formed by, for example, a method including: adding the fumed silica fine particles and the dispersant to water (the concentration of the silica fine particles may be, for example, from 10 mass % to 20 mass %); pre-dispersing the mixture using a high-speed rotational wet method colloid mil (such as CLEARMIX (trade name, manufactured by M Technique)) at a high rotation condition of, for example, 10,000 rpm (preferably in a range of from 5,000 to 20,000 rpm) for a period of, for example, 20 minutes (preferably from 10 to 30 minutes); adding the crosslinking agent (such as the boric compound) and an aqueous PVA solution (the amount of PVA in which is adjusted to achieve, for example, one-third of that of the fumed silica fine particles) and dispersing, at the same condition as the pre-dispersing, the obtained mixture. The resulting coating liquid has a uniform sol state. A porous ink-receiving layer having a three-dimensional network structure can be obtained by applying this coating liquid to a support by a coating method explained below and then drying.

In preferable embodiments, in the case in which plural polyvinyl alcohols are used together, a polyvinyl alcohol having a lower polymerization degree may be firstly added to the dispersion system and dispersed, and a polyvinyl alcohol having a higher polymerization degree may be later added to the dispersion system and dispersed. The temperature at which the polyvinyl alcohols are added may be preferably in a range of from 10° C. to 50° C. in view of making the viscosity of the ink-receiving layer be lower.

In embodiments, in view of providing higher image density and improving humidity resistance and water resistance (resistance to bleeding) of images formed on the ink-receiving layer, the formation of the ink-receiving layer may be performed so that the content of the polyvinyl alcohol having the polymerization degree of 2400 or more becomes from 12% by mass to 35% by mass with respect to the content of all inorganic fine particles contained in the ink-receiving layer (or with respect to the sum of content(s) of all inorganic fine particles contained in the coating liquid for forming the ink-receiving layer), and the content of the polyvinyl acetal (PVAc) becomes from 1% by mass to 7% by mass with respect to the content of the fumed silica fine particles contained in the ink-receiving layer (or with respect to the content of the fumed silica fine particles contained in the coating liquid for forming the ink-receiving layer). In more specific embodiments, the preparing of the coating liquid may include preparing the coating liquid so that the mass ratio of the content of the polyvinyl alcohol having the polymerization degree of 2400 or more to the content of all inorganic fine particles in the coating liquid is from 12% by mass to 35% by mass and the mass ratio of the content of the water-soluble polyvinyl acetal to the content of the fumed silica in the coating liquid is from 1% by mass to 7% by mass. Details of the PVA and the PVAc used in the formation of the ink-receiving layer are respectively the same as those explained for the PVA and the PVAc contained in the ink-receiving layer.

The aqueous dispersion including the fumed silica and the dispersant may be prepared by preparing a fumed silica dispersion liquid and then adding the thus obtained aqueous dispersion liquid to the aqueous solution of the dispersant, adding the aqueous solution of the dispersant to the aqueous dispersion liquid, or mixing these at the same time. In embodiments, instead of using the aqueous dispersion liquid of the fumed silica, the fumed silica in a powder state may be added to the aqueous solution of the dispersant.

After mixing the fumed silica and the dispersant, the thus obtained mixture liquid may be treated by using a disperser to form fine particles, whereby an aqueous dispersion liquid of particles having an average particle size of from 50 nm to 300 nm may be obtained. Conventionally known dispersing machines such as a high-speed dispersing machine, a medium stirring dispersing machine (such as a ball mill or a sand mill), an ultrasonic dispersing machine, a colloid mill dispersing machine, and high-pressure dispersing machine may be used as the dispersing machine used for obtaining the aqueous dispersion. Among these dispersing machines, a medium stirring dispersing machine, a colloid mill dispersing machine, and high-pressure dispersing machine are preferable in view of efficiently dispersing pilled fine particles to be formed.

Water, an organic solvent, or a mixture solvent of these solvents may be used as a solvent in preparing the coating liquid for forming the ink-receiving layer. Examples of the organic solvent used for this coating operation include alcohols such as methanol, ethanol, n-propanol, i-propanol and methoxypropanol, ketones such as acetone and methyl ethyl ketone, tetrahydrofuran, acetonitrile, ethyl acetate and toluene.

A cationic polymer may be used as the dispersant. Examples of the cationic polymer include a homopolymer of a mordant monomer (namely, a monomer having a primary- to tertiary-amino group or its salt or a monomer having a quaternary ammonium salt group) or a copolymer or condensed polymer of the mordant monomer and other monomers (hereinafter referred to as “non-mordant monomer”). These polymer mordants may be used in any form of a water-soluble polymer or water-soluble latex particles. Details and embodiments of these monomers used in the formation of the ink-receiving layer are respectively the same as those explained for the monomers which can be contained in the ink-receiving layer. In embodiments, the dispersant may be a silane coupling agent.

The amount of the dispersant to be added is from 0.1 mass % to 30 mass %, and more preferably 1 mass % to 10 mass %, based on the content of the fumed silica fine particles.

Formation of Ink-Receiving Layer

The ink-receiving layer may be formed by applying, onto a support, the coating liquid which is prepared in the preparation of the coating liquid for forming the ink-receiving layer. Examples of the method of applying the coating liquid include conventionally-known methods using an extrusion die coater, an air doctor coater, a blade coater, a rod coater, a knife coater, a squeeze coater, a reverse roll coater or a bar coater.

In embodiments, the ink-receiving layer of the inkjet receiving medium may be preferably formed by a method which includes: applying, onto a coating layer formed by applying the coating liquid for forming ink-receiving layer, applying a basic liquid having a pH of 8 or more onto the coated layer either (1) simultaneously with the application of the coating liquid or (2) during the drying of the coating layer formed by the application of the coating liquid but before the coated layer shows a decreasing rate of drying; and then curing and crosslinking the resulting coated layer. That is, the ink-receiving layer may be preferably produced by introducing the basic liquid having a pH of 8 or more during the period in which the coating layer shows a constant rate of drying after applying the ink-receiving layer forming liquid.

When the ink-receiving layer is formed by curing and crosslinking in this manner, the ink absorbing property may be improved and cracking of the layer can be suppressed.

The basic liquid having a pH of 8 or more may contain a crosslinking agent as necessary. The use of the basic liquid having a pH value is 8 or higher as an alkali solution may promote curing of the coating layer. When the pH value is 8 or more and is not too near acidic value, the crosslinking agent may sufficiently promote the crosslinking reaction of polyvinyl alcohol contained in the coating liquid, thus suppressing bronzing, cracking on the ink-receiving layer or the like.

The basic liquid having a pH of 8 or more may be prepared, for example, by adding a metal compound (for example, 1% to 5%) and a base compound (for example, 1% to 5%), and optionally para-toluenesulfonic acid (for example, 0.5% to 3%), to ion-exchanged water and then stirring the mixture sufficiently. The“%” in each formulation herein refers to % by mass of solids content.

The expression “before the coated layer exhibits a decreasing rate of drying” usually refers to the period within a few minutes from the completion of the application of the ink-receiving layer forming liquid. During the period, the coated layer exhibits a constant rate of drying in which the quantity of the solvent (dispersing medium) contained in the coated layer decreases in proportion to time. For instance, the period during which the coated layer exhibits a “constant rate of drying” is described in Chemical Engineering Handbook (pp. 707-712, Maruzen Co., Ltd., Oct. 25, 1980).

After coating of the ink-receiving layer forming liquid, the coated layer is dried until the coated layer exhibits a decreasing rate of drying. In general, the coated layer is dried at a temperature of from 40° C. to 180° C. for a period of from 0.5 minutes to 10 minutes. This drying time may be usually suitable though the drying time naturally depends on the coating amount.

In embodiments, in view of improving gloss and ink-receiving property, the coated layer may be preferably dried at a temperature of from 70° C. to 120° C. until the solid content of the coated layer becomes from 14% to 20% and then further dried at a temperature of from 40° C. to 60° C. until the solid content of the coated layer becomes from 21% to 27%, and may be more preferably dried at a temperature of from 80° C. to 110° C. until the solid content of the coated layer becomes from 15% to 19% and then further dried at a temperature of from 45° C. to 55° C. until the solid content of the coated layer becomes from 22% to 26%.

Support

The support may be a transparent support containing a transparent material such as a plastic or an opaque support containing opaque material such as paper. In embodiments, the support may be preferably a transparent support or an opaque support having a high glossiness in view of taking advantage of transparency of the ink-receiving layer. In embodiments, a read-only optical disc such as CD-ROM or DVD-ROM, a recordable optical disc such as CD-R or DVD-R, or a rewritable optical disc may be used as the support, the ink-receiving layer being formed on the label surface.

In embodiments, the transparent support may be preferably formed of a transparent material capable of enduring radiant heat applied during use in OHPs and backlight displays. Examples of the material include polyesters (e.g., polyethylene terephthalate (PET)), polysulfones, polyphenylene oxides, polyimides, polycarbonates and polyamides. Among these, polyesters may be preferable, and polyethylene terephthalate may be more preferable.

The thickness of the transparent support is not particularly limited. In embodiments, it may be preferably from 50 μm to 200 μm in view of easy handling.

The opaque and high-gloss support is preferably those where the surface on which the ink-receiving layer is to be formed has a glossiness of 40% or higher. The glossiness is a value determined according to the method described in JIS P-8142 (test method for specular gloss of paper and paperboard at 75°), the disclosure of which is herein incorporated by reference. Specific examples of the opaque and high-gloss support include: high-gloss paper supports such as art paper, coat paper, cast coat paper and baryta paper used for a silver-halide photographic support; opaque, high-gloss films prepared by incorporating white pigment or the like into plastic films formed, for example, of polyesters (e.g., polyethylene terephthalate (PET)), polysulfones, polyphenylene oxides, polyimides, polycarbonates or polyamides (the films being optionally subjected to a surface calender treatment); and water non-absorptive supports prepared by providing, onto the surface of the transparent supports or high-gloss films containing white pigment or the like, a coating layer made of polyolefin which may contain or not contain a white pigment. Specific examples thereof further include white pigment-containing foamed polyester films (e.g., foamed PET containing polyolefin fine particles and voids formed through stretching) and resin-coated paper used for silver-halide photographic printing paper.

The thickness of the opaque support is not particularly limited. In embodiments, it may be preferably from 50 μm to 300 μm from the viewpoint of handleability. In embodiments, the surface of the support may be treated with, for example, a corona discharge treatment, glow discharge treatment, flame treatment or UV ray irradiation treatment in view of improving wettability and adhesiveness.

Raw paper may be used for paper supports such as the resin-coated paper. The raw paper is made from a mixture mainly containing wood pulp and optionally containing synthetic pulp (e.g., polypropylene) and/or synthetic fiber (e.g., nylon and polyester). Examples of the wood pulp include LBKP, LBSP, NBKP, NBSP, LDP, NDP, LUKP and NUKP. In embodiments, the wood pulp mixture may preferably contain a larger amount of LBKP, NBSP, LBSP, NDP and/or LDP, each containing a lot of short fibers. The relative LBSP and/or LDP amount with respect to the mixture may be preferably from 10% by mass to 70% by mass.

Chemical pulp, which contains few impurities, may be preferably used for forming the raw paper, and examples thereof include a sulfuric acid salt pulp and a sulfinic acid salt pulp. Bleached pulp with improved whiteness may also be used.

The raw paper may appropriately further contain, for example, a sizing agent (e.g., higher fatty acids and alkyl ketene dimers), a white pigment (e.g., calcium carbonate, talc and titanium oxide), a paper strengthening agent (e.g., starch, polyacrylamide and polyvinyl alcohol), a fluorescent whitening agent, a water retention agent (e.g., polyethylene glycols), a dispersant, and/or a softening agent (e.g., quaternary ammoniums).

In embodiments, the freeness of the pulp used for papermaking may be preferably from 200 mL to 500 mL according to the CSF. In embodiments, the pulp obtained after beating may preferably have a fiber length (as measured according to JIS P-8207, the disclosure of which is herein incorporated by reference) satisfying the following: a total of a 24-mesh-screen-remnant and a 42-mesh-screen-remnant is from 30% by mass to 70% by mass, and a 4-mesh-screen-remnant is 20% by mass or less.

In embodiments, the basis weight of the raw paper may be preferably from 30 g/m² to 250 g/m², and more preferably from 50 g/m² to 200 g/m². The thickness of the raw paper may be preferably 40 μm to 250 μm. The raw paper may be provided with high smoothness by performing a calender treatment during or after papermaking. The density of the raw paper may is generally from 0.7 g/m² to 1.2 g/m² as measured according to JIS P-8118, the disclosure of which is herein incorporated by reference. The strength of the raw paper may be preferably from 20 g to 200 g as measured according to JIS P-8143, the disclosure of which is herein incorporated by reference. In embodiments, the pH of the raw paper may be from 5 to 9 as measured by a hot-water extraction method according to JIS P-8113, the disclosure of which is herein incorporated by reference.

The surface of the raw paper may be coated with a surface-sizing agent. Examples of the surface-sizing agent include those which can be incorporated into the raw paper.

The front and back surfaces of the raw paper may be coated with polyethylene to form polyethylene-coated paper. Low-density polyethylene (LDPE) and/or high-density polyethylene (HDPE) may be used as the polyethylene in many cases, although other LLDPE or other polypropylene may also be partly used therefor.

In embodiments, the polyethylene layer provided on the side where the ink-receiving layer is to be formed may be preferably made from polyethylene to which rutile- or anatase-type titanium oxide, a fluorescent whitening agent and/or an ultramarine blue pigment is added as is widely performed for forming photographic printing paper in view of improving opaqueness, whiteness and hue. The content of the titanium oxide with respect to the amount of polyethylene may be preferably from about 3% by mass to about 20% by mass, and more preferably from 4% by mass to 13% by mass. The thickness of the polyethylene layers which may be provided on the front and/or back surface(s) is not respectively particularly limited. In embodiments, the thicknesses may be respectively preferably from 10 μm to 50 μm. In embodiments, an undercoat layer may be provided on the polyethylene layer in view of improving (providing) adhering property of the polyethylene layer to the ink-receiving layer. Examples of a material of the undercoat layer include an aqueous polyester, gelatin, and PVA. A thickness of the undercoat layer may be preferably from 0.01 μm to 5 μm.

The polyethylene-coated paper may be used as gloss paper. Alternatively, like general-use photographic printing paper, it may be provided with a matte surface or a silk-finish surface by subjecting it to an embossing treatment when polyethylene is melt-extruded onto the raw paper surface.

In embodiments, the support may be provided with a back-coat layer. The back-coat layer may contain a white pigment, an aqueous binder, and/or other components. Details and embodiments of the white pigments, water-soluble binders, and other components which may be contained in the back-coat layer are described in paragraphs [0063] to [0064] of JP-A No. 2009-107319.

### EXAMPLES

Hereinafter, specific embodiments are described in more detail by reference to Examples, but Examples should not be construed as limiting the invention. In Examples, the terms “parts” and “%” refer to “parts by mass” and “% by mass”, respectively.

### Example 1

### Preparation of Support

50 parts of LBKP made from Acasia and 50 parts of LBKP made from Aspen were respectively refined by a disk refiner to a Canadian freeness of 300 mL to prepare a pulp slurry. To the pulp slurry were added 1.3% of a cationic starch (trade name: CATO 304L, available from Nippon NSC Ltd.), 0.15% of an anionic polyacrylamide (trade name: POLYACRON ST-13, available from Seiko PMC Corporation), 0.29% of an alkyl ketene dimer (trade name: SIZEPINE K, available from Arakawa Chemical Industries, Ltd.), 0.29% of an epoxidized behenic amide, and 0.32% of a polyamide polyamine epichlorohydrin (trade name: ARAFIX 100, available from Arakawa Chemical Industries, Ltd.), and thereto was further added 0.12% of an antifoaming agent. The ratios were based on the mass of the pulp.

The resultant pulp slurry was subjected to paper-making by a fourdrinier paper machine, and then dried. In the drying, the felt surface of the web was pressed against a drum dryer cylinder via a dryer canvas, the tensile force of the dryer canvas being adjusted to 1.6 kg/cm. Then, polyvinyl alcohol (trade name: KL-118, available from Kuraray Co., Ltd.) was applied at 1 g/m² to both the surfaces of the base paper by a size press, and the applied polyvinyl alcohol was dried and subjected to a calender treatment. The base paper (the raw paper) had a basis weight of 166 g/m² and a thickness of 160 μm.

The wire surface (back surface) of the resultant base paper was subjected to a corona discharge treatment and then coated with a high-density polyethylene to a thickness of 25 μm by a melt extrusion machine, so that a resin layer having a matte surface (hereinafter, the surface of the thermoplastic resin layer is referred to as “back surface”) was formed. The resin layer forming the back surface was further subjected to a corona discharge treatment and then coated, in an amount of 0.2 g/m² on a dry weight basis, with a dispersion liquid containing, as an antistatic agent, aluminum oxide (trade name: ALUMNA SOL 100, manufactured by Nissan Chemical Industries, Ltd.) and colloidal silicon dioxide (trade name: SNOWTEX O, manufactured by Nissan Chemical Industries, Ltd.) in the ratio of 1:2 (ratio by mass) dispersed in water.

The felt surface (front surface) not having the thermoplastic resin layer was subjected to a corona discharge treatment, and then a low-density polyethylene having a MRF (melt flow rate) of 3.8 by being prepared to contain 10% of anatase-type titanium dioxide, 0.3% of ultramarine manufactured by Tokyo Printing Ink Mfg. Co., Ltd., and 0.08% of a fluorescent brightener (trade name: WHITEFLOUR PSN CONC, manufactured by Nippon chemical works Co., Ltd.) was melt-extruded to a thickness of 25 μm onto the felt surface by a melt extrusion machine, to form a highly glossy thermoplastic resin layer on the front surface of the base paper (hereinafter, this highly glossy surface is referred to as a “front surface”). A water-resistant support was thus obtained. The water-resistant support was made into a long roll body having a width of 1.5 m and a wound length of 3000 m as a support.

Preparation of Coating Liquid a for Forming Ink-Receiving Layer

Among the components in the formulation shown below, (1) fumed silica, (2) ion exchanged water, and (3) water soluble polymer were mixed and dispersed using a ultrasonic disperser manufactured by SMT Co., Ltd.). The resulting dispersion liquid was stored under a liquid temperature of 45° C. for 20 hours. After that, to the dispersion liquid, the following (4) boric acid, (5) 7%-aqueous polyvinyl alcohol solution, (6) polyvinyl acetal, (7)10%-aqueous surfactant solution, and (8) polyaluminum chloride were added under the condition of 30° C., whereby a coating liquid A for forming an ink-receiving layer was prepared.

The coating liquid A for forming an ink-receiving layer had the sum of the content of the polyvinyl alcohol and the content of the polyvinyl acetal of 24% by mass with respect to the content of the fumed silica fine particles in the coating liquid A for forming an ink-receiving layer.

Formulation of Coating Liquid a for Forming Ink-Receiving Layer

| | | |
|---|---|---|
| (1) Fumed silica (“AEROSIL 300SV” (trade name), | 100 | parts |
| manufactured by Nippon Aerosil Co., Ltd.) | | |
| (2) Ion exchanged water | 520 | parts |
| (3) Water soluble polymer, 51.5% aqueous solution | 8.7 | parts |
| (dispersing agent) (“SHALLOL DC902P” (trade name), | | |
| manufactured by Dai-ichi Kogyo Seiyaku Co., Ltd.) | | |
| (4) Boric acid (crosslinking agent) | 45.4 | parts |
| (5) Polyvinyl alcohol, 7% aqueous solution | 286 | parts |
| (“PVA-235” (trade name), manufactured by Kuraray | | |
| Co., Ltd.; polymerization degree: 3500) | | |
| (6) Polyvinyl acetal, 20% solution (“S-LEC KW-3” | 20 | parts |
| (trade name), manufactured by Sekisui Chemical Co., | | |
| Ltd.; polymerization degree: 3500) | | |
| (7) Surfactant, 10% aqueous solution (“EMULGEN 109P” | 5 | parts |
| (trade name), manufactured by Kao Corporation) | | |
| (8) Polyaluminum chloride (“ALFINE 83” (trade name), | 15 | parts |
| manufactured by Taimei Chemical Co., Ltd.) | | |

Preparation of Crosslinking Agent Solution 1

A crosslinking agent solution 1 was prepared by solving (mixing) the components in the following formulation under ambient temperature.

Formulation of Crosslinking Agent Solution 1:

| | | |
|---|---|---|
| (1) Ion exchanged water | 89.4 | parts |
| (2) Ammonium carboxide (pH adjusting agent) | 4 | parts |
| (3) Boric acid (crosslinking agent) | 0.65 | parts |
| (4) Surfactant, 10% aqueous solution | 6 | parts |
| (“EMULGEN 109P” (trade name), manufactured | | |
| by Kao Corporation) | | |

Preparation of Inkjet Recording Medium (1)

The front surface of the water-resistant support was subjected to a corona discharge treatment, and the coating liquid A for forming an ink-receiving layer was coated on the undercoat layer by using a slide bead coater in a coating amount of 140 g/m². The coated layer was dried at 80° C. (wind velocity: 3 msec) in a hot air dryer for 2 minutes. During the drying, the coated layer showed constant-rate of drying. Immediately after the 2 minutes-drying, the resultant was immersed in the crosslinking agent liquid 1 for 1 second. The resultant was then dried at 80° C. for 10 minutes. As the result, an inkjet recording medium (1) was obtained.

### Examples 2 to 9 and Comparative Examples 1 to 3

Inkjet recording media of Examples 2 to 9 and Comparative examples 1 to 3 were respectively prepared in the similar manner as the inkjet recording medium of Example 1, except that the coating liquids for forming an ink-receiving layer B to L, which were prepared by changing the kinds, polymerization degree, and content ratio of PVA and PVAc, and the amount of the ion exchanged water in the coating liquid A for forming an ink-receiving layer as shown in the following Table 1, were used in place of the coating liquid A for forming an ink-receiving layer.

1. Evaluation of Viscosity of Coating Liquid

The viscosity of each of the coating liquids for forming an ink-receiving layer was measured by using a B-type viscosimeter (manufactured by Tokyo Keisoku Co., Ltd.) at 35° C. and was graded under the following evaluation criteria. Results of the evaluation are shown in Table 1.

### Evaluation Criteria:

A: Viscosity was 100 mPa·s or smaller.
B: Viscosity was larger than 100 mPa·s but 150 mPa·s or smaller.
C: Viscosity was larger than 150 mPa·s but 250 mPa·s or smaller.
D: Viscosity was more than 250 mPa·s.

2. Evaluation of Image Density (Dmax)

A solid black image was printed on each of the inkjet recording media obtained in the Examples and Comparative examples by using an inkjet printer (trade name: A700, manufactured by Seiko Epson Corporation) under the condition of the temperature of 23° C. and the relative humidity of 50%. After having the thus-obtained sample left stand under the condition of the temperature of 23° C. and the relative humidity of 50% for 24 hours, the visual reflection density of the resultant solid black image was measured with a reflection densitometer (trade name: X-RITE 310TR, manufactured by X-rite Incorporated.) The thus-measured density was graded according to the following evaluation criteria.

### Evaluation Criteria:

A: 2.5 or more
B: 2.2 or more but less than 2.5
C, 2.0 or more but less than 2.2
D: Less than 2.0

3. Evaluation of Humidity Resistance (Bleeding Resistance)

Lattice-shaped patterns (length of one side of lattice: 0.28 mm) in which a red Dmax part and a white part are adjacent to each other were recorded on ink jet recording mediums to be a rectangle of 3 cm under the environmental conditions of 23° C. and 50% RH. Immediately after the recording, the ink jet recording mediums were moved to a place under the environmental conditions of 23° C. and 90% RH and were left for 7 days. After the 7 days, the ink jet recording media were sufficiently dried under the environmental conditions of 23° C. and 50% RH, then degrees of bleeding were evaluated visually, and graded according to the following evaluation criteria.

### Evaluation Criteria:

A: No bleeding was recognized.
B: Bleeding could not be substantially identified, although there was a little bleeding.
C: Practically acceptable, although bleeding was recognized.
D: Practically intolerable. There was great bleeding of a range.

4. Water-Resistance

Each inkjet recording medium that was cut out in a size of 3 cm×10 cm was immersed in ion-exchanged water for 1 hour in an environment of 23° C.; and then it was taken out of the water and air-dried. The ink-receiving layer of the inkjet recording medium after dried was subjected to visual observation to see the extent of cracks and changes in glossiness degree. Then, in accordance with the observation, the inkjet recording medium was graded as follows.

### Evaluation Criteria:

A: No crack and no change in glossiness degree were observed at all.
B: Practically acceptable. The glossiness degree changed slightly, but no crack was observed.
C: A slight crack was observed.
D: Practically intolerable. Many cracks were observed, and they were not acceptable on practical use.

TABLE 1

| | | Polyvinyl Alcohol PVA | | | Polyvinyl Acetal PVAc | |
|---|---|---|---|---|---|---|
| | | | Polymer- | Content Ratio | | Content Ratio |
| | Coating | Kind/ | ization | (to Silica) | Kind/ | (to Silica) |
| | Liquid | Content | Degree | [mass %] | Content | [mass %] |
| Ex. 1 | A | PVA235 | 3500 | 20 | KW-3 | 4 |
| | | 286 parts | | | 20 parts | |
| Ex. 2 | B | PVA235 | 3500 | 20 | KW-10 | 4 |
| | | 286 parts | | | 16 parts | |
| Ex. 3 | C | PVA235 | 3500 | 29 | KW-3 | 4 |
| | | 414 parts | | | 20 parts | |
| Ex. 4 | D | PVA235 | 3500 | 15 | KW-3 | 4 |
| | | 214 parts | | | 20 parts | |
| Ex. 5 | E | PVA235 | 3500 | 20 | KW-3 | 1 |
| | | 286 parts | | | 5 parts | |
| Ex. 6 | F | PVA235 | 3500 | 20 | KW-3 | 5 |
| | | 286 parts | | | 25 parts | |
| Ex. 7 | G | PVA224 | 2400 | 20 | KW-3 | 4 |
| | | 286 parts | | | 20 parts | |
| Ex. 8 | H | PVA235 | 3500 | 20 | KW-3 | 0.5 |
| | | 286 parts | | | 25 parts | |
| Ex. 9 | I | PVA235 | 3500 | 10 | KW-3 | 10 |
| | | 286 parts | | | 50 parts | |
| Comp. 1 | J | PVA235 | 3500 | 20 | — | 0 |
| | | 286 parts | | | | |
| Comp. 2 | K | PVA217 | 1700 | 20 | KW-3 | 4 |
| | | 286 parts | | | 20 parts | |
| Comp. 3 | L | PVA235 | 3500 | 50 | KW-3 | 4 |
| | | 715 parts | | | 20 parts | |

| | | | Evaluation | | | |
|---|---|---|---|---|---|---|
| | PVA + PVAc/ | Ion | Coating | | | |
| | Silica | Exchange | Liquid | Image | Humidity | Water |
| | [mass %] | Water | Viscosity | Density | Resistance | Resistance |
| Ex. 1 | 24 | 520 parts | A | A | A | A |
| Ex. 2 | 24 | 524 parts | A | A | B | A |
| Ex. 3 | 33 | 392 parts | B | B | A | A |
| Ex. 4 | 19 | 592 parts | A | B | A | B |
| Ex. 5 | 21 | 535 parts | B | A | B | A |
| Ex. 6 | 25 | 515 parts | B | A | A | A |
| Ex. 7 | 24 | 520 parts | A | B | A | B |
| Ex. 8 | 20.5 | 538 parts | C | A | C | A |
| Ex. 9 | 20 | 490 parts | A | C | A | C |
| Comp. 1 | 20 | 540 parts | D | — | — | — |
| Comp. 2 | 24 | 520 parts | A | D | A | D |
| Comp. 3 | 52 | 91 parts | D | C | C | C |

As shown in Table 1, Examples provided suppressed coating liquid viscosity and high image density in spite of the use of fumed silica and polyvinyl alcohol having a high polymerization degree in combination. Further, images obtained by Examples had excellent humidity resistance and water resistance.

In contrast, Comparative example 1, in which polyvinyl acetal is not used, revealed large degree of viscosity increase and did not allow formation of an ink-receiving layer. Comparative example 2, in which polyvinyl alcohol having a low polymerization degree was used, revealed insufficient image density and water resistance.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording medium comprising a support and an ink-receiving layer provided on the support, the ink-receiving layer comprising fumed silica, polyvinyl alcohol having a polymerization degree of 2400 or more, and water-soluble polyvinyl acetal, and the mass ratio of the sum of the content of the polyvinyl alcohol having a polymerization degree of 2400 or more and the content of the water-soluble polyvinyl acetal included in the ink-receiving layer to the content of all inorganic fine particles including the fumed silica in the ink-receiving layer being 50% or less.

2. The inkjet recording medium of claim 1, wherein in ink-receiving layer, the content of the polyvinyl alcohol having a polymerization degree of 2400 or more is from 12% by mass to 35% by mass with respect to the content of all inorganic fine particles, and the content of the water-soluble polyvinyl acetal is from 1% by mass to 7% by mass with respect to the content of the fumed silica.

3. The inkjet recording medium of claim 1, wherein the saponification degree of the polyvinyl alcohol having a polymerization degree of 2400 or more is from 78 mol % to 96 mol %.

4. A method of producing an inkjet recording medium, the method comprising: preparing a coating liquid by adding polyvinyl alcohol having a polymerization degree of 2400 or more and water-soluble polyvinyl acetal to a silica dispersion comprising fumed silica so that the mass ratio of the sum of the content of the polyvinyl alcohol having a polymerization degree of 2400 or more and the content of the water-soluble polyvinyl acetal to the content of all inorganic fine particles in the coating liquid becomes 50% or less; and forming an ink-receiving layer by applying the coating liquid onto a support.

5. The method of producing an inkjet recording medium of claim 4, wherein the preparing of the coating liquid comprises preparing the coating liquid so that the mass ratio of the content of the polyvinyl alcohol having a polymerization degree of 2400 or more to the content of all inorganic fine particles in the coating liquid is from 12% by mass to 35% by mass and the mass ratio of the content of the water-soluble polyvinyl acetal to the content of the fumed silica in the coating liquid is from 1% by mass to 7% by mass.
